(19) United States
(12) Patent Application Publication
(10) Pub. No.: US 2024/0305971 A1
(43) Pub. Date: Sep. 12, 2024

(54) APPARATUS AND METHOD FOR HANDLING SOR-CMCI CONFIGURATION IN WIRELESS NETWORK

(71) Applicant: SAMSUNG ELECTRONICS CO., LTD., Suwon-si, Gyeonggi-do (KR)

(72) Inventors: Danish Ehsan HASHMI, Bangalore (IN); Arijit SEN, Bangalore (IN); Brijendra Kumar ASTHANA, Bangalore (IN); Koustav ROY, Bangalore (IN); Lalith KUMAR, Bangalore (IN)

(21) Appl. No.: 18/546,580

(22) PCT Filed: Feb. 16, 2022
(86) PCT No.: PCT/KR2022/002297

§ 371 Date: Aug. 15, 2023

(30) Foreign Application Priority Data
Feb. 17, 2021 (IN) 202141006673
Jan. 29, 2022 (IN) 202141006673

(51) Int. Cl. H04W 8/12; H04W 48/18; H04W 76/19; H04W 84/04

(52) U.S. Cl. CPC H04W 8/12; H04W 48/18; H04W 76/19; H04W 84/042

(57) ABSTRACT

According to various embodiments, a method performed by a user equipment (UE) in a wireless network may include receiving a steering of roaming connected mode control information (SOR-CMCI) configuration or SOR information from a network entity, initiating a timer in response to receiving the SOR-CMCI configuration or the SOR information from the network entity, identifying whether the UE is in an idle mode before expiry of the timer, in case that the UE is in the idle mode, identifying a condition under which the UE is in the idle mode, and performing, based on the condition, a first operation of allowing the timer to continue running, or a second operation of stopping the timer and selecting a public land mobile network (PLMN).

### TECHNICAL FIELD

The present disclosure relates to a wireless network, and more specifically related to a method and apparatus for handling a steering of roaming connected mode control information (SOR-CMCI) configuration in the wireless network.

### BACKGROUND ART

In a visited public land mobile network (VPLMN), a home operator may provide steering of roaming (SOR) information and/or steering of roaming connected mode control information (SOR-CMCI) information to a user equipment (UE) when the UE attaches to a network. The SOR and SOR-CMCI information help the UE to move to preferred public land mobile network (PLMN) in a visited country or a roaming country in a time bound manner. When UE is in the roaming area, a home public land mobile network (HPLMN) prefers the UE to receive services from HPLMN's preferred roaming partner. If UE receives services from non-preferred roaming operator then that the operator may end up charging more to the HPLMN. Thus the selection of the operator by the UE in roaming area has direct impact on the revenues of the HPLMN. When the UE is already registered with a VPLMN-1 in a roaming area, the HPLMN may choose to move the UE to a VPLMN-2, to achieve this HPLMN sends the SOR information with list of preferred PLMN information to the UE. When the UE receives this SOR information UE is in connected mode, at this point how long UE should wait to get into an IDLE mode before moving to preferred PLMN of the HPLMN for e.g. VPLMN-2 is controlled by the SOR-CMCI configuration. Based on the SOR-CMCI configuration the UE starts Tsor-CM timers and waits for it to get into IDLE state if UE does not get into IDLE state and if Tsor-CM timer expires, the UE will abort the ongoing services, deregister with VPLMN-1 and attempt to obtain service from HPLMN's preferred roaming partner. If UE gets into idle state before the expiry of Tsor-cm timer UE assumes the services are completed.

FIG. 1 is a flow chart S100 illustrating a scenario of handling a SOR-CMCI configuration in a wireless network, according to prior art. At S102, the method includes receiving the SOR-CMCI configuration or the SOR information from a network entity. At S104, the method includes initiating the Tsor-cm timer in response to receiving the SOR-CMCI configuration or the SOR information from the network entity. At S106, the method includes detecting whether the UE is in an idle mode before expiry of the Tsor-cm timer. At S108, the method includes aborting the ongoing service, stopping the Tsor-cm timer and performing a PLMN selection to obtain service on a higher priority PLMN. The issue at S108 is UE does not consider the reasons why it has entered IDLE state for example if it was due to radio signal conditions i.e. the lower layer failures, then UE could recover and there is a possibility of current ongoing services to continue till the allowed time of Tsor-cm timer. But as per prior art UE does not take into account the reasons it has entered IDLE mode it aborts the ongoing service and triggers the higher priority PLMN selection procedure.

It is desired to address the above mentioned disadvantages or other short comings or at least provide a useful alternative.

### DISCLOSURE OF INVENTION

### Technical Problem

The principal object of the embodiments herein is to provide a method and apparatus for handling a steering of roaming connected mode control information (SOR-CMCI) configuration in a wireless network.

Another object of the embodiments herein is to provide that while a Tsor-cm timer is running and if the UE goes to an idle state not due to a lower layer failure, the Tsor-cm timer is stopped and the UE performs PLMN selection to select higher priority PLMN. While the Tsor-cm timer is running and if the UE goes to the idle state due to the lower layer failure, the Tsor-cm timer is not stopped and the UE will not perform the PLMN selection to select higher priority PLMN because a NAS recovery is possible and the UE can continue with its services.

### Solution to Problem

Accordingly, the embodiment herein is to provide a method for handling a steering of roaming connected mode control information (SOR-CMCI) configuration in a wireless network. The method includes receiving, by a UE, the SOR-CMCI configuration or SOR information from a network entity (e.g., home public land mobile network (HPLMN) or an Equivalent HPLMN (EHPLMN)). Further, the method includes initiating, by the UE, a Tsor-cm timer in response to receiving the SOR-CMCI configuration or the SOR information from the network entity (e.g., HPLMN or the EHPLMN). Further, the method includes detecting, by the UE, whether the UE is in an idle mode before expiry of the Tsor-cm timer. Further, the method includes determining, by the UE, whether the UE is in the idle mode due to a lower layer failure. Further, the method includes performing, by the UE, one of: allowing the Tsor-cm timer to continue running in response to determining that the UE is in the idle mode due to the lower layer failure, and stopping the Tsor-cm timer and performing a PLMN selection to obtain service on a higher priority PLMN in response to determining that the UE is in the idle mode not due to the lower layer failure.

In an embodiment, allowing the Tsor-cm timer to continue running includes determining, by the UE, the UE is in the idle mode due to a lower layer failure comprises performing, by the UE, Non-access stratum (NAS) signal recovery from the lower layer failure, and continuing, by the UE, the ongoing service.

Accordingly, the embodiment herein is to provide a UE for handling a SOR-CMCI configuration in a wireless network. The UE includes a SOR-CMCI configuration controller communicatively coupled to a memory and a processor. The SOR-CMCI configuration controller is configured to receive the SOR-CMCI configuration or a SOR information from a network entity (e.g., HPLMN or an EHPLMN). Further, the SOR-CMCI configuration controller is configured to initiate a Tsor-cm timer in response to receiving the SOR-CMCI configuration or the SOR information from the network entity (e.g., HPLMN or the EHPLMN). Further, the SOR-CMCI configuration controller is configured to detect whether the UE is in an idle mode before expiry of the Tsor-cm timer. Further, the SOR-CMCI configuration controller is configured to determine whether the UE is in the idle mode due to a lower layer failure. Further, the SOR-CMCI configuration controller is configured to perform one of allow the Tsor-cm timer to continue running in response to determining that the UE is in the idle mode due to the lower layer failure, and stop the Tsor-cm timer and perform a PLMN selection to obtain service on a higher priority PLMN in response to determining that the UE is in the idle mode not due to the lower layer failure.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

This method is illustrated in the accompanying drawings, throughout which like reference letters indicate corresponding parts in the various figures. The embodiments herein will be better understood from the following description with reference to the drawings, in which:

FIG. 1 is a flow chart illustrating a scenario of handling a steering of roaming connected mode control information (SOR-CMCI) configuration in a wireless network;

FIG. 2 illustrates an overview of a wireless network for handling a SOR-CMCI configuration according to an embodiment;

FIG. 3a shows various hardware components of a user equipment (UE), according to an embodiment;

FIG. 3b shows various hardware components of a network entity, according to an embodiment;

FIG. 4 is a flow chart illustrating a method for handling a SOR-CMCI configuration in a wireless network, according to an embodiment; and

FIG. 5 is an example flow chart illustrating a scenario of handling the SOR and/or SOR-CMCI information when a HPLMN does not know a storage status of the SOR and/or SOR-CMCI information in the UE, according to an embodiment.

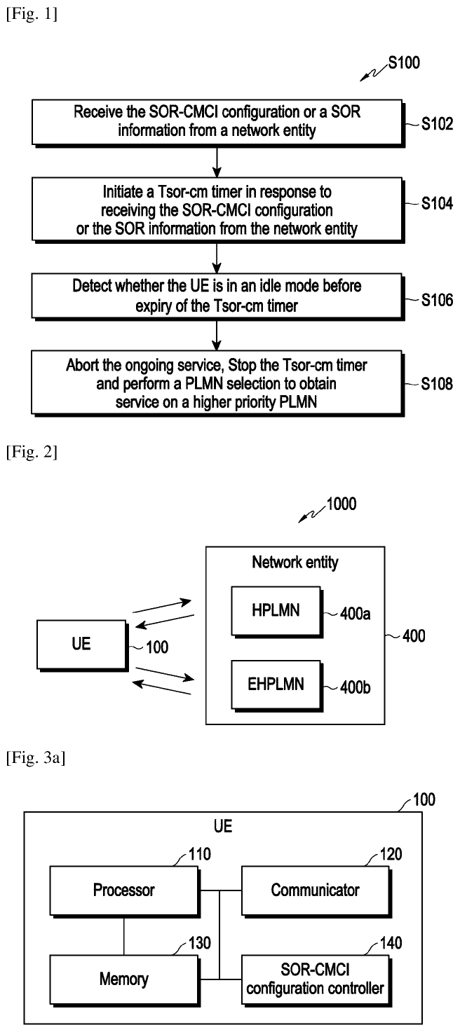

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for handling a steering of roaming connected mode control information (SOR-CMCI) configuration in a wireless network. The method includes receiving, by a user equipment (UE), the SOR-CMCI configuration or SOR information from a network entity (e.g., a home public land mobile network (HPLMN) or an equivalent public land mobile network (EHPLMN)). Further, the method includes initiating, by the UE, a Tsor-cm timer in response to receiving the SOR-CMCI configuration or the SOR information from the network entity. Further, the method includes detecting, by the UE, whether the UE is in an idle mode before expiry of the Tsor-cm timer. Further, the method includes determining, by the UE, whether the UE is in the idle mode due to a lower layer failure. Here, the lower layer failure may be one of conditions (e.g., radio signal conditions). Further, the method includes performing, by the UE, one of: allowing the Tsor-cm timer to continue running in response to determining that the UE is in the idle mode due to the lower layer failure, and stopping the Tsor-cm timer and performing a PLMN selection to obtain service on a higher priority PLMN in response to determining that the UE is in the idle mode not due to the lower layer failure.

The proposed method can be used to handle the SOR-CMCI configuration in the wireless network may without any extra signaling and resources. In the proposed method, while a Tsor-cm timer is running and if the UE goes to an idle state not due to a lower layer failure, the Tsor-cm timer is stopped and the UE performs PLMN selection to select higher priority PLMN. While the Tsor-cm timer is running and if the UE goes to the idle state due to the lower layer failure, the Tsor-cm timer is not stopped and the UE will not perform the PLMN selection to select higher priority PLMN because a NAS recovery is possible and the UE can continue with its services.

Referring now to the drawings and more particularly to FIGS. 2 to 5, where similar reference characters denote corresponding features consistently throughout the figures, there are shown preferred embodiments.

FIG. 2 illustrates an overview of a wireless network 1000 for handling the SOR-CMCI configuration, according to an embodiment as disclosed herein. In an embodiment, the wireless cellular network 1000 includes a UE 100 and a network entity including a HPLMN 400a and an EHPLMN 400b. The wireless cellular network 1000 may be, for example, but not limited to a 5G network, a 6G network and an O-RAN network. The UE 100 may be, for example, but not limited to a laptop, a desktop computer, a notebook, a relay device, a Device-to-Device (D2D) device, a vehicle to everything (V2X) device, a smartphone, a tablet, an immersive device, and an internet of things (IoT) device.

The UE 100 is configured to receive a SOR-CMCI configuration i.e. steering of roaming connected mode control information (SOR-CMCI) which is a HPLMN information to control the timing for a UE in connected mode to move to idle mode in order to perform steering of roaming or the SOR information from the network entity 400 (e.g., the HPLMN 400a or the EHPLMN 400b). Upon receiving the SOR-CMCI configuration or the SOR information from the network entity 400, the UE 100 is configured to initiate a Tsor-cm timer and detect whether the UE 100 is in an idle mode before expiry of the Tsor-cm timer. Further, the UE 100 is configured to determine whether the UE 100 is in the idle mode due to the lower layer failure. Upon determining that the UE 100 is in the idle mode not due to the lower layer failure, the UE 100 is configured to stop the Tsor-cm timer and perform the PLMN selection to obtain service on the higher priority PLMN. Upon determining that the UE 100 is in the idle mode due to the lower layer failure, the UE 100 is configured to perform the NAS signal recovery (also called as recovery of NAS signalling connection) from the lower layer failure and continue the ongoing service.

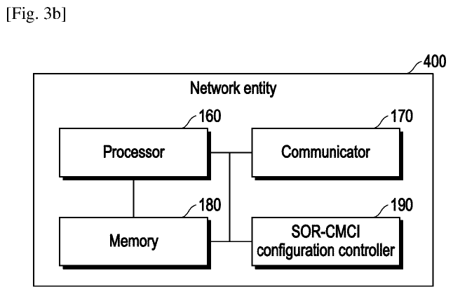

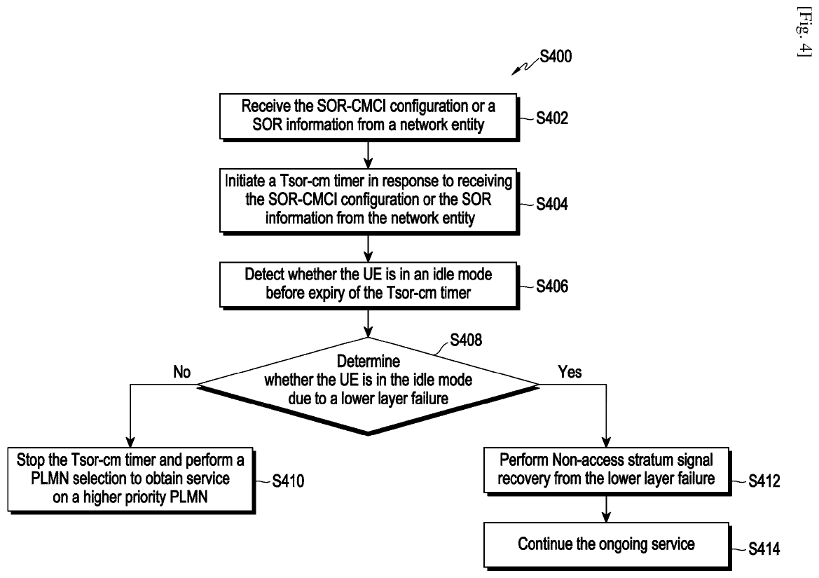

FIG. 3a shows various hardware components of the UE 100, according to an embodiment as disclosed herein. In an embodiment, the UE 100 includes a processor 110, a communicator 120, a memory 130, and a SOR-CMCI configuration controller 140. The processor 110 is coupled with the communicator 120, the memory 130 and the SOR-CMCI configuration controller 140. Here, the processor 110 and the SOR-CMCI configuration controller 140 may be implemented as at least one processor. The communicator 120 may include a transmitter and a receiver, or a transceiver.

The SOR-CMCI configuration controller 140 is configured to receive the SOR-CMCI configuration or the SOR information from the network entity 400. Upon receiving the SOR-CMCI configuration or the SOR information from the network entity 400, the SOR-CMCI configuration controller 140 is configured to initiate the Tsor-cm timer and detect whether the UE 100 is in the idle mode before expiry of the Tsor-cm timer. Further, the SOR-CMCI configuration controller 140 is configured to determine whether the UE 100 is in the idle mode due to the lower layer failure. Upon determining that the UE 100 is in the idle mode not due to the lower layer failure, the SOR-CMCI configuration controller 140 is configured to stop the Tsor-cm timer and perform the PLMN selection to obtain service on the higher priority PLMN. Upon determining that the UE 100 is in the idle mode due to the lower layer failure, the SOR-CMCI configuration controller 140 is configured to perform the NAS signal recovery from the lower layer failure and continue the ongoing service.

The SOR-CMCI configuration controller 140 is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor 110 is configured to execute instructions stored in the memory 130 and to perform various processes. The communicator 120 is configured for communicating internally between internal hardware components and with external devices via one or more networks. The memory 130 also stores instructions to be executed by the processor 110. The memory 130 may include non-volatile storage elements. Examples of such non-volatile storage elements may include magnetic hard discs, optical discs, floppy discs, flash memories, or forms of electrically programmable memories (EPROMs) or electrically erasable and programmable memories (EEPROMs). In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 130 is non-movable. In certain examples, a non-transitory storage medium may store data that can, over time, change (e.g., in Random Access Memory (RAM) or cache).

Although the FIG. 3a shows various hardware components of the UE 100 but it is to be understood that other embodiments are not limited thereon. In other embodiments, the UE 100 may include less or more number of components. Further, the labels or names of the components are used only for illustrative purpose and does not limit the scope of the invention. One or more components can be combined together to perform same or substantially similar function in the UE 100.

FIG. 3b shows various hardware components of a network entity 400, according to an embodiment as disclosed herein. In an embodiment, the network entity 400 includes a processor 160, a communicator 170, a memory 180, and a SOR-CMCI configuration controller 190. The processor 160 is coupled with the communicator 170, the memory 180 and the SOR-CMCI configuration controller 190. Here, the processor 160 and the SOR-CMCI configuration controller 190 may be implemented as at least one processor. The communicator 170 may include a transmitter and a receiver, or a transceiver.

The SOR-CMCI configuration controller 190 is configured to transmit the SOR-CMCI configuration or the SOR information to a UE 100.

The SOR-CMCI configuration controller 190 is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor 160 is configured to execute instructions stored in the memory 180 and to perform various processes. The communicator 170 is configured for communicating internally between internal hardware components and with external devices via one or more networks. The memory 180 also stores instructions to be executed by the processor 160. The memory 180 may include non-volatile storage elements. Examples of such non-volatile storage elements may include magnetic hard discs, optical discs, floppy discs, flash memories, or forms of EPROMs or EEPROMs. In addition, the memory 180 may, in some examples, be considered a non-transitory storage medium. The term “non-transitory” may indicate that the storage medium is not embodied in a carrier wave or a propagated signal. However, the term “non-transitory” should not be interpreted that the memory 180 is non-movable. In certain examples, a non-transitory storage medium may store data that can, over time, change (e.g., in a RAM or cache).

Although the FIG. 3b shows various hardware components of the network entity 400 but it is to be understood that other embodiments are not limited thereon. In other embodiments, the network entity 400 may include less or more number of components. Further, the labels or names of the components are used only for illustrative purpose and does not limit the scope of the invention. One or more components can be combined together to perform same or substantially similar function in the network entity 400.

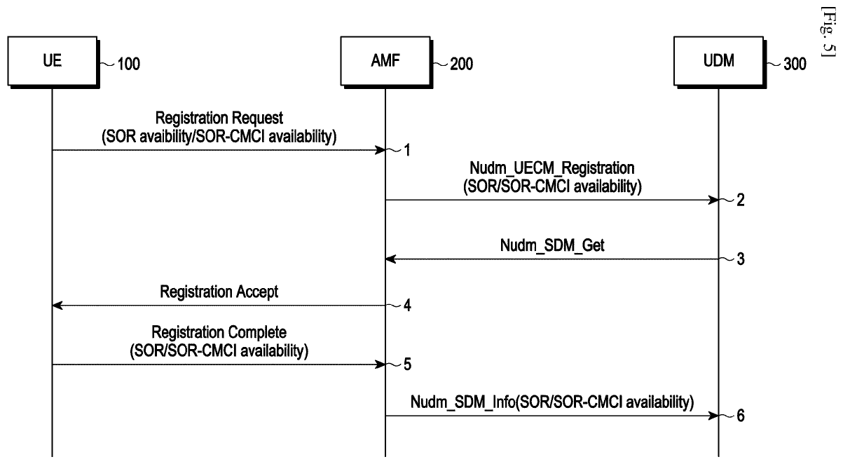

FIG. 4 is a flow chart S400 illustrating a method for handling the SOR-CMCI configuration in the wireless network 1000, according to an embodiment as disclosed herein. The operations (S502-S514) are performed by the SOR-CMCI configuration controller 140.

At S402, the method includes receiving the SOR-CMCI configuration or the SOR information from the network entity 400. At S404, the method includes initiating the Tsor-cm timer in response to receiving the SOR-CMCI configuration or the SOR information from the network entity 400 (e.g., the HPLMN 400a or the EHPLMN 400b). The receiving from the HPLMN 400a or the EHPLMN 400b corresponds to the source is the HPLMN 400a or the EHPLMN 400b but if the UE 100 is camping on the VPLMN network the UE 100 will receive the SOR or SOR-CMCI information/configuration from the HPLMN 400a/EHPLMN 400b via the VPLMN to the UE 100. At S406, the method includes detecting whether the UE 100 is in the idle mode before expiry of the Tsor-cm timer. At S408, the method includes determining whether the UE 100 is in the idle mode due to the lower layer failure.

In response to determining that the UE 100 is in the idle mode not due to the lower layer failure, at S410, the method includes stopping the Tsor-cm timer and performing the PLMN selection to obtain service on the higher priority PLMN. In response to determining that the UE 100 is in the idle mode due to the lower layer failure, at S412, the method includes performing the NAS signal recovery from the lower layer failure. At S414, the method includes continuing the ongoing service.

FIG. 5 is an example flow chart S700 illustrating the scenario of handling the SOR-CMCI information when the HPLMN does not know the storage status of the SoR-CMCI information in the UE 100, according to the embodiments as disclosed herein.

In general, according to prior art, the UE 100 should delete stored SOR and SOR-CMCI information in the ME whenever the USIM is removed and other USIM is inserted. Now there can be situation where HPLMN has to know whether the stored SOR, the SOR-CMCI is being removed or not in ME. In some situation, if the HPLMN already send SOR information in the visited PLMN so it may choose not to send SOR information with an operator controlled PLMN selector with Access Technology (Home PLMN send SOR information with no change of the “Operator controlled PLMN selector with Access Technology” list stored in the UE 100 is needed). Similarly, the home operator may not provide the SOR-CMCI if it deems that there is no change in the SOR-CMCI and ME have the updated SOR_CMCI.

In case, the UE 100 removes it's the USIM and connects and other USIM is inserted it back then also according to prior art stored information in the ME will be lost. In this scenario Tsor-cm timer for corresponding services or PDU sessions will not be applied properly as the UE 100 will not receive it yet. Similarly SOR information is lost, ME will not be applying preferred PLMN search.

However, the issue arises when in some cases when the UE 100 delete SOR/SOR-CMCI information stored in the UE 100. E.g. when USIM is changed, the UE 100 will delete the stored SOR/SOR-CMCI information. If the UE doesn't have SOR/SOR_CMCI, how HPLMN will detect that the UE 100 need SOR information? HPLMN can send that ‘no change of the “Operator Controlled PLMN Selector with Access Technology” list stored in the UE 100 is needed and thus no list of preferred PLMN/access technology combinations is provided’.

The above issues is addressed as: The HPLMN needs to be informed about the availability of SOR, SOR-CMCI in ME in advance, in order to be able to decide whether or not to provide SOR information with Preferred PLMN list and add SOR-CMCI to the SOR information provided to the UE 100. The UE 100 indicates to the HPLMN about the availability of the SOR, SOR-CMCI indication in the registration request message as shown in the FIG. 5. The UEs 100 send the information to the home PLMN user data management (UDM) 300 in the below signaling message

In another embodiment, the solution includes the UE 100 sending the SOR, the SOR-CMCI availability indication to the Home PLMN UDM in the registration request message as below.
1. SOR availability indication, and
2. SOR-CMCI availability indication.

An access and mobility management function (AMF) 200 sends above indication received in the registration request to the UDM 300 in the Nudm_UECM_Registration

In another embodiment, the solution includes the UE 100 sending the SOR, SOR-CMCI availability indication to the Home PLMN UDM in the registration request message as below.
1. SOR availability indication, and
2. SOR-CMCI availability indication.

The AMF 200 sends the above indication received in the registration request to the UDM 300 in the Nudm_UECM_Registration or any other signal.

The UDM 300 asks the UE 100 to send acknowledgement for the SOR information in Nudm_SDM_Get. The UE 100 send the SOR availability indication, SOR-CMCI availability indication together with Acknowledgement in the registration accept message in SOR transparent container.

In another embodiment, the solution includes the UE 100 sending the SOR, SOR-CMCI availability indication to the Home PLMN UDM in the registration request message as below.
1. SOR availability indication, and
2. SOR-CMCI availability indication.

The AMF 200 sends above indication received in the registration request to the UDM 300 in the Nudm_UECM_Registration.

If network doesn't send the SOR information, the UE 100 deem that AMF 200 have suppressed above information and not sent to the UDM.

If the SOR availability indication is sent to the network which says SOR information is not available in ME or deleted in ME and network doesn't send SOR information with list of Operator Controlled PLMN Selector with Access Technology, the UE 100 deem that network is fake, if the current chosen VPLMN is not contained in the list of “PLMNs where registration was aborted due to SOR”, and is not part of “User Controlled PLMN Selector with Access Technology” list and the UE 100 is not in manual mode of operation, release the current N1 NAS signaling connection locally and attempt to obtain service on a higher priority PLMN by acting as if timer T that controls periodic attempts has expired

If SOR-CMCI availability indication sends to network which says SOR-CMCI information is not available in ME or deleted in ME and doesn't receive SOR-CMCI information. The UE 100 shall release N1 signaling connection and search for high priority PLMN when high priority service like emergency call is ongoing (in this case UE 100 shall release N1 signaling connection after ongoing priority service is ended)

In another embodiment, the solution includes the UE 100 sending the SOR, SOR-CMCI availability indication to the Home PLMN UDM in the registration request message as below.
1. SOR availability indication, and
2. SOR-CMCI availability indication

The AMF 200 sends above indication received in the registration request to the UDM 300 in the Nudm_UECM_Registration. The UDM 300 ask the UE 100 to send acknowledgement for the SOR information in Nudm_SDM_Get. The UE 100 sends the SOR availability indication, SOR-CMCI availability indication together with Acknowledgement in the registration accept message which is sent to UDM 300 using the Nudm_SDM_Info.

If the UDM 300 gets the different information about SOR availability indication, SOR-CMCI availability indication in the Nudm_UECM_Registration, Nudm_SDM_Info, it send SOR information and/or SOR-CMCI indication through Downlink NAS transport procedure as per the TS 23.122 subclauseC.3 Stage-2 flow for steering of UE 100 in HPLMN or VPLMN after registration based on information received in Nudm_SDM_Info.

In another embodiment, the solution includes the UE 100 sending the SOR, SOR-CMCI availability indication to the Home PLMN UDM in the registration request message as below.
1. SOR availability indication, and
2. SOR-CMCI availability indication

The AMF 200 sends above indication received in the registration request to the UDM 300 in the Nudm_UECM_Registration
1. UE send SOR availability indication, SOR-CMCI availability indication together with Acknowledgement in the registration accept message (irrespective of UE 100 have send indication in registration request message).
2. UE 100 start timer for receiving SOR information through downlink NAS transport (say timer X).

If the UDM 300 gets the different information about SOR availability indication, SOR-CMCI availability indication in the Nudm_UECM_Registration, Nudm_SDM_Info or if it will sends SOR information and/or SOR-CMCI indication through Downlink NAS transport procedure for steering of UE 100 in the HPLMN or the VPLMN after registration

If the UE 100 doesn't receive DL NAS transport before timer expiry (timer X), the UE 100 deem that network is stopping NAS transport message. The UE 100 take below action.

If SOR availability indication send to network which says SOR information is not available in ME or deleted in ME and network doesn't send SOR information with list of Operator Controlled PLMN Selector with Access Technology, the UE 100 deem that network is fake, if the current chosen VPLMN is not contained in the list of “PLMNs where registration was aborted due to SOR”, and is not part of “User Controlled PLMN Selector with Access Technology” list and the UE 100 is not in manual mode of operation, release the current N1 NAS signaling connection locally and attempt to obtain service on a higher priority PLMN by acting as if timer T that controls periodic attempts has expired

If SOR-CMCI availability indication sends to network which says SOR-CMCI information is not available in ME or deleted in ME. The UE 100 shall release N1 signaling connection and search for high priority PLMN when high priority service like emergency call is ongoing (in this case UE shall release N1 signaling connection after ongoing priority service is ended)

Timer X can be configured in the UE 100 by default or received from SIM or can be sent over the NAS message.

In another embodiment, the solution includes the UE 100 sending the SOR, SOR-CMCI availability indication to the Home PLMN UDM in the registration request message as below.
1. SOR availability indication, and
2. SOR-CMCI availability indication

The UDM 300 send the SOR transparent container with information received from the UE 100 in the registration request about the availability of SOR availability indication and/or SOR-CMCI availability indication, in the Nudm_SDM_Get. The UE 100 takes below action:

SOR availability indication received in SOR transparent container with registration accept is not matching with information sent in registration request, the UE 100 deem that network is fake, if the current chosen VPLMN is not contained in the list of “PLMNs where registration was aborted due to SOR”, and is not part of “User Controlled PLMN Selector with Access Technology” list and the UE 100 is not in manual mode of operation, release the current N1 NAS signalling connection locally and attempt to obtain service on a higher priority PLMN by acting as if timer T that controls periodic attempts has expired

SOR-CMCI availability indication received in SOR transparent container with registration accept is not matching with information sent in registration request, the UE 100 shall release N1 signaling connection and search for high priority PLMN when high priority service like emergency call is ongoing (in this case UE shall release N1 signaling connection after ongoing priority service is ended).

In another embodiment, the solution includes the UE 100 sending the SOR availability indication, SOR-CMCI availability indication to the Home PLMN UDM as a transparent container in registration complete message if said information is deleted in the UE.

In another embodiment, the solution includes the solutions described in the previous embodiments, USIM can notify to the ME to send SOR availability indication/SOR-CMCI availability indication to HPLMN UDM.

If SIM doesn't notify to ME, in this case ME assume that it need to send SOR availability indication/SOR-CMCI availability indication to HPLMN UDM.

Referring to the FIG. 5, at 1, the UE 100 sends the registration request including the SOR availability/SOR-CMCI availability to the AMF 200. At 2, the AMF 200 sends a Nudm_UECM_Registration including the SOR/SOR-CMCI availability to the UDM 300. At 3, UDM 300 sends the Nudm_SDM_Get to the AMF 200. At 4, AMF 200 sends the registration accept to the UE 100. At 5, the UE 100 sends the registration complete including the SOR/SOR-CMCI availability to the AMF 200. At 6, the AMF 200 sends the Nudm_SDM_Info including the SOR/SOR-CMCI availability to the UDM 300.

Another problem includes handling Tsor-cm timers in case of radio failures. In case of radio failures or lower layer failures, the UE 100 goes to the idle mode temporarily and stop Tsor-cm timers. The UE 100 will initiate higher PLMN selection in this case.

In the embodiment while Tsor-cm timer is running and radio link or lower link failure reported to the NAS:

A. The UE 100 shall not stop Tsor-cm timer if already running.

B. If there is no uplink data pending to send in the UE 100, then the UE 100 need not send the mobility registration due to RRC Connection failure. Ideally in this case the UE 100 moves to the idle mode and higher priority PLMN can be selected.

If SOR-CMCI is not present, the UE 100 shall that consider Tsor-cm timer is disabled.

In this embodiment, If match all criteria is not present in the SOR-CMCI, the UE 100 shall consider match all criteria is present with Tsor-cm timer is disabled. The UE 100 shall not start Tsor-cm timer for the service which is not matching with any of the SOR-CMCI rules.

In this embodiment, if Tsor-cm timer value is set to 0 in the SOR-CMCI rules, the UE 100 consider Tsor-cm is disabled.

In this embodiment, the UE 100 performing a PLMN selection to obtain service on the higher priority PLMN is done based on prior art principles i.e. if the UE 100 has a list of available and allowable PLMNs in the area and based on this list or any other implementation specific means, the UE 100 determines that there is a higher priority PLMN than the selected VPLMN; or the UE 100 does not have a list of available and allowable PLMNs in the area and is unable to determine whether there is a higher priority PLMN than the selected VPLMN using any other implementation specific means;

The various actions, acts, blocks, steps, or the like in the flow charts S400 may be performed in the order presented, in a different order or simultaneously. Further, in some embodiments, some of the actions, acts, blocks, steps, or the like may be omitted, added, modified, skipped, or the like without departing from the scope of the invention.

According to various embodiments, a method for handling a steering of roaming connected mode control information (SOR-CMCI) configuration in a wireless network 1000 may be provided. The method may comprise receiving, by a user equipment (UE) 100, the SOR-CMCI configuration or SOR information from a network entity 400, initiating, by the UE 100, a Tsor-cm timer in response to receiving the SOR-CMCI configuration or the SOR information from the network entity 400, detecting, by the UE 100, whether the UE 100 is in an idle mode before expiry of the Tsor-cm timer, determining, by the UE 100, whether the UE 100 is in the idle mode due to a lower layer failure, and performing, by the UE 100, one of: allowing the Tsor-cm timer to continue running in response to determining that the UE 100 is in the idle mode due to the lower layer failure, and stopping the Tsor-cm timer and performing a PLMN selection to obtain service on a higher priority PLMN in response to determining that the UE 100 is in the idle mode not due to the lower layer failure.

According to various embodiments, allowing the Tsor-cm timer to continue running may comprise determining, by the UE 100, the UE 100 is in the idle mode due to the lower layer failure, performing, by the UE 100, non-access stratum (NAS) signal recovery from the lower layer failure, and continuing, by the UE 100, the ongoing service.

According to various embodiments, a user equipment (UE) 100 for handling a SOR-CMCI configuration in a wireless network 1000 may be provided. The UE 100 may comprise a memory 130, a processor 110, and a SOR-CMCI configuration controller 140, communicatively coupled to the memory 130 and the processor 100, configured to: receive the SOR-CMCI configuration or a SOR information from a network entity 400, initiate a Tsor-cm timer in response to receiving the SOR-CMCI configuration or the SOR information from the network entity 400, detect whether the UE 100 is in an idle mode before expiry of the Tsor-cm timer, determine whether the UE 100 is in the idle mode due to a lower layer failure, and perform one of: allow the Tsor-cm timer to continue running in response to determining that the UE 100 is in the idle mode due to the lower layer failure, and stop the Tsor-cm timer and perform a PLMN selection to obtain service on a higher priority PLMN in response to determining that the UE 100 is in the idle mode not due to the lower layer failure.

According to various embodiments, allow the Tsor-cm timer to continue running may comprise determine the UE 100 is in the idle mode due to the lower layer failure, perform non-access stratum (NAS) signal recovery from the lower layer failure, and continue the ongoing service.

According to various embodiments, a method performed by a user equipment (UE) in a wireless network may comprise receiving a steering of roaming connected mode control information (SOR-CMCI) configuration or SOR information from a network entity, initiating a timer in response to receiving the SOR-CMCI configuration or the SOR information from the network entity, identifying whether the UE is in an idle mode before expiry of the timer, in case that the UE is in the idle mode, identifying a condition under which the UE is in the idle mode, and performing, based on the condition, a first operation of allowing the timer to continue running, or a second operation of stopping the timer and selecting a public land mobile network (PLMN).

According to various embodiments, performing, based on the condition, the first operation or the second operation may comprise, in case that the condition includes a lower layer failure, performing the first operation.

According to various embodiments, the first operation of allowing the timer to continue running may comprise performing non-access stratum (NAS) signal recovery from the lower layer failure, and continuing an ongoing service.

According to various embodiments, performing, based on the condition, the first operation or the second operation may comprise, in case that the condition does not include a lower layer failure, performing the second operation.

According to various embodiments, selecting the PLMN may comprise selecting a PLMN with a priority higher than a threshold priority for a service.

According to various embodiments, the condition may include a radio signal condition.

According to various embodiments, the timer may include a Tsor-cm timer.

According to various embodiments, the network entity may include at least one of a home PLMN (HPLMN) or an equivalent HPLMN (EHPLMN).

According to various embodiments, a user equipment (UE) in a wireless network may comprise a transceiver, and at least one processor connected to the transceiver and configured to: receive a steering of roaming connected mode control information (SOR-CMCI) configuration or SOR information from a network entity, initiate a timer in response to receiving the SOR-CMCI configuration or the SOR information from the network entity, identify whether the UE is in an idle mode before expiry of the timer, in case that the UE is in the idle mode, identifying a condition under which the UE is in the idle mode, and perform, based on the condition, a first operation of allowing the timer to continue running, or a second operation of stopping the timer and selecting a public land mobile network (PLMN).

According to various embodiments, the at least one processor may be configured to: in case that the condition includes a lower layer failure, perform the first operation.

According to various embodiments, the at least one processor may be configured to: perform non-access stratum (NAS) signal recovery from the lower layer failure, and continue an ongoing service.

According to various embodiments, the at least one processor may be configured to: in case that the condition does not include a lower layer failure, perform the second operation.

According to various embodiments, the at least one processor may be configured to: select a PLMN with a priority higher than a threshold priority for a service.

According to various embodiments, the condition may include a radio signal condition.

According to various embodiments, the network entity may include at least one of a home PLMN (HPLMN) or an equivalent HPLMN (EHPLMN).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless network, the method comprising:
receiving a steering of roaming connected mode control information (SOR-CMCI) configuration or steering of roaming (SOR) information from a network entity;
initiating a timer in response to receiving the SOR-CMCI configuration or the SOR information from the network entity;
identifying that the UE is in an idle mode before expiry of the timer;
identifying whether the UE is in the idle mode due to a lower layer failure; and
in case that the UE is in the idle mode due to the lower laver failure, allowing the timer to continue running.

2. The method of claim 1, further comprising:
in case that the UE is in the idle mode not due to the lower layer failure, stopping the timer.

3. The method of claim 1, wherein allowing the timer to continue running comprises:
performing non-access stratum (NAS) signal recovery from the lower layer failure.

4. The method of claim 2, further comprising:
in case that the UE is in the idle mode not due to the lower layer failure, performing a public land mobile network (PLMN) selection.

5. The method of claim 4, wherein performing the PLM-N selection comprises:
selecting a PLMN with a priority higher than a threshold priority.

6. (canceled)

7. The method of claim 1, wherein the timer includes a Tsor-cm timer.

8. The method of claim 1, wherein the network entity includes at least one of a home PLMN (HPLMN) or an equivalent HPLMN (EHPLMN).

9. A user equipment (UE) in a wireless network, the UE comprising:
a transceiver; and
at least one processor connected to the transceiver and configured to:
receive a steering of roaming connected mode control information (SOR-CMCI) configuration or steering of roaming (SOR) information from a network entity,
initiate a timer in response to receiving the SOR-CMCI configuration or the SOR information from the network entity,
identify that the UE is in an idle mode before expiry of the timer;
identify whether the UE is in the idle mode due to a lower layer failure, and
in case that the UE is in the idle mode due to the lower layer failure, allow the tinier to continue running.

10. The UE of claim 9, wherein the at least one processor is configured to:
in case that the UE is in the idle mode not due to the lower layer failure, stop the timer.

11. The UE of claim 9, wherein the at least one processor is configured to:
perform non-access stratum (NAS) signal recovery from the lower layer failure.

12. The UE of claim 9, wherein the at least one processor is configured to:
in case that the UE is in the idle mode not due to the lower layer failure, perform a public land mobile network (PLMN) selection.

13. The UE of claim 12, wherein the at least one processor is configured to:
select a PLMN with a priority higher than a threshold priority.

14. (canceled)

15. The UE of claim 9, wherein the network entity includes at least one of a home PLMN (HPLMN) or an equivalent HPLMN (EHPLMN).

16. The UE of claim 9, wherein the timer includes a Tsor-cm timer.
